(19) United States
(12) Patent Application Publication
(10) Pub. No.: US 2014/0278806 A1
(43) Pub. Date: Sep. 18, 2014

(54) SYSTEMS AND METHODS FOR PROVIDING VEHICLE MARKET ANALYSIS

(71) Applicant: Manheim Investments, Inc., Atlanta, GA (US)

(72) Inventors: Annie Duguid, Atlanta, GA (US); Amy Mills, Atlanta, GA (US); Joe George, Atlanta, GA (US); Krista Marlatt, Atlanta, GA (US); Bonnie Hensler, Atlanta, GA (US)

(73) Assignee: Manheim Investments, Inc., Atlanta, GA (US)

(21) Appl. No.: 14/213,976

(22) Filed: Mar. 14, 2014

Related U.S. Application Data
(60) Provisional application No. 61/794,944, filed on Mar. 15, 2013.

(51) Int. Cl. G06Q 30/02

(52) U.S. Cl. CPC G06Q 30/0206
USPC 705/7.35

(57) ABSTRACT

The present disclosure relates to computer-implemented systems and methods for providing vehicle market analysis. An example method may include receiving vehicle data associated with a vehicle and determining, based at least in part on the vehicle data, wholesale market data and retail market data associated with the vehicle. The method may also include determining, based at least in part on the wholesale market data and the retail market data, one or more price recommendations for the vehicle. The method may also include determining, based at least in part on the wholesale market data and the retail market data, one or more location recommendations for the vehicle.

### TECHNICAL FIELD

The present disclosure generally relates to systems and methods to optimize the placement of products, in some embodiments vehicles, into a wholesale marketplace, and in some cases auction wholesale marketplace.

### BACKGROUND

With the advent of e-commerce, online businesses conduct vast amounts of transactions every day. As such, users are able to perform extensive online research using robust search engines before purchasing a product. Sellers and/or consignors of vehicles are often interested in finding cost-effective means of determining how and where to sell their vehicles. To this end, sellers and/or consignors generally consider various factors that may affect the sales price of the vehicles, such as transportation, location, and/or the like. However, many sellers may lack insight into the wholesale markets and the relationship between wholesale market and retail markets. Thus, sellers may be conducting vehicle sales under less than optimal circumstances.

### BRIEF DESCRIPTION OF THE DRAWINGS

Reference will now be made to the accompanying figures and diagrams, which are not necessarily drawn to scale, and wherein:

FIG. 1 shows a system for providing vehicle market analysis according to one or more example embodiments.

FIG. 2 shows a data flow diagram for providing vehicle market analysis according to one or more example embodiments.

FIG. 3 shows a flow diagram of a method for providing vehicle market analysis, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, the repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “device” refers, in general, to an electronic communication device, both wired and wireless, and more particularly to one or more of the following: a portable electronic device, a telephone (e.g., cellular phone, smartphone), a computer (e.g., laptop computer, tablet computer, desktop computer, wearable computer), a portable media player, a personal digital assistant (PDA), a kiosk computer for public use, entertainment/gaming system, web-enabled television, or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of a central server may include a web server hosting one or more web pages. Some examples of web pages may include social networking web pages. Another example of a server may be a cloud server that hosts web services for one or more computer devices.

As used herein, unless otherwise specified, the term “network” may correspond to various types of networks capable of communicating via one or more communication interfaces. Such communication interfaces may include, but are not limited to: personal area networks (PANs), wired local area networks (LANs), wireless local area networks (WLANs), wireless wide area networks (WWANs), and other wired and wireless system interfaces. To this end, the wireless system interfaces may include the hardware and software to broadcast and receive messages either using the Wi-Fi Direct Standard (see Wi-Fi Direct specification published in October 2010) and/or the IEEE 802.11 wireless standard (see IEEE 802.11-2007, published Mar. 8, 2007; IEEE 802.11n-2009, published October 2009), or a combination thereof. Furthermore, the communication interfaces may utilize acoustic, radio frequency, optical, or other signals to exchange data between the user device 105 and another device such as an access point, a host computer, a server, a router, a reader device, and the like. Additionally, the network may include, but is not limited to: the Internet, a private network, a virtual private network, a wireless wide area network, a local area network, a metropolitan area network, a telephone network, a cellular network (e.g., Global System for Mobile, Code Division Multiple Access, Long-Term Evolution, and/or Long-Term Evolution Advanced networks) and so forth.

As used herein, unless otherwise specified, the term “web page” may correspond to one or more web pages as part of one or more websites.

Embodiments of the present disclosure may generally relate to a service provider configured to analyze wholesale market data and retail market data associated with a vehicle. Such analysis may provide a basis for determining one or more recommendations associated with the vehicle. Broadly, a service provider application may provide a user of the service provider, such as a dealer, OEM, financial institution, rental company, or any other consignor/seller of a vehicle, market analysis to facilitate buying and/or selling vehicles.

For example, some embodiments may include a user device, a service provider server, and one or more third-party service devices in communication with each other over a network. A user of the user device may desire a determination as to where, and at what price, to buy and/or sell one or more vehicles. As such, the user, via the user device, may input certain vehicle data and transmit the vehicle data to the service provider server. Such vehicle data may include information identifying the one or more vehicles, such as make, model, year, quantity, Vehicle Identification Number (VIN), color, and/or the like.

According to one or more embodiments, a service provider application may be included in the service provider server. As such, the service provider application may receive the vehicle data from the user device and analyze data related to one or more markets associated with the vehicle data. Such markets may include wholesale markets and retail markets, and the analysis of such markets may facilitate determination of certain recommendations associated with buying and/or selling the one or more vehicles. Wholesale market data may include information related to vehicle condition, color, history, locations, wholesale pricing information, auction capacity, auction inventory, auction schedule, and other auction data, reconditioning data, and/or various other types of data, including, but not limited to, auction and service costs and fees. Retail market data may include, but is not limited to, market day supply data, quantity of respective vehicles in respective markets, retail pricing information, market capacity and demand, and/or other retail information.

In some embodiments, the service provider application may also provide estimates for various outside-services associated with placing a vehicle into a particular auction. For instance, in some embodiments, the service provider application may provide transportation cost data associated with moving a vehicle to a particular auction. In other embodiments, such outside-service data might be obtained from a third party service device, such as a computing system associated with one or more transportation providers.

For example, a user may be interested in selling 30 Toyota Camrys and may wish to determine where to sell, and at what price to sell, the 30 Toyota Camrys. As such, the user may transmit, via a user device, vehicle data associated with the 30 Toyota Camrys to the service provider application. Based on the vehicle data, the service provider application may access and/or communicate with various sources to determine wholesale market data and/or retail market data associated with Toyota Camrys. For instance, the service provider application may communicate with one or more third-party service devices to determine such data. To this end, third-party service providers may include auction sites, auction servers, financial institutions, and/or any other entity capable of monitoring, tracking, or otherwise storing information related to wholesale market data and/or retail market data. In other embodiments, the service provider server may have access to such information itself, such as via a database. To this end, the service provider application may communicate with a database, which may be local to the service provider server or may be remote from the service provider servers, to also facilitate determining the wholesale and/or retail market data.

According to certain implementations, the service provider may determine and/or generate, based at least in part on the wholesale market data and/or the retail market data, market analysis data associated with the one or more vehicles. Such market analysis data may include one or more price recommendations and/or one or more location recommendations at which to sell the Camrys. For instance, in determining the market analysis data, the service provider application may consider, for respective markets (e.g., geographical locations, respective auctions, etc.) respective market impacts of placing 30 Camrys (or any subset of the 30 Camrys) for sale in those respective markets. For example, the service provide may determine that a first market is currently saturate with Camrys while a second market may still have room from Camrys without negatively driving down their prices beyond a certain threshold. To this end, the service provider may determine to place the 30 Camrys in the second market. In addition to market impacts, the service provider application may consider various other factors in determining the price and location recommendations, such as transportation costs, taxes, location, and/or the like. Additionally, such recommendations may be transmitted, displayed, and/or otherwise provided to the user device.

Thus, according to one or more embodiments of the disclosure, a method is provided. The method may include receiving vehicle data associated with a vehicle and determining, based at least in part on the vehicle data, wholesale market data and retail market data associated with the vehicle. The method may also include determining, based at least in part on the wholesale market data and the retail market data, one or more price recommendations for the vehicle. The method may also include determining, based at least in part on the wholesale market data and the retail market data, one or more location recommendations for the vehicle.

According to one or more embodiments of the disclosure, a system is provided. The system may have at least one processor and at least one memory storing computer-executable instructions. When the instructions are executed by the at least one processor, the instructions may cause the at least one processor to receive vehicle data associated with a vehicle. The instructions may also cause the at least one processor to determine, based at least in part on the vehicle data, wholesale market data and retail market data associated with the vehicle. Additionally, the instructions may cause the at least one processor to determine, based at least in part on the wholesale market data and the retail market data, one or more price recommendations for the vehicle. The instructions may also cause the at least one processor to determine, based at least in part on the wholesale market data and the retail market data, one or more location recommendations for the vehicle.

According to one or more embodiments of the disclosure, a non-transitory computer-readable medium is provided. The non-transitory computer-readable medium may have embodied thereon instructions executable by at least one processor. The instructions may cause the one or more processors to receive vehicle data associated with a vehicle. The instructions may also cause the at least one processor to determine, based at least in part on the vehicle data, wholesale market data and retail market data associated with the vehicle. Additionally, the instructions may cause the at least one processor to determine, based at least in part on the wholesale market data and the retail market data, one or more price recommendations for the vehicle. The instructions may also cause the at least one processor to determine, based at least in part on the wholesale market data and the retail market data, one or more location recommendations for the vehicle.

The above principles, and perhaps others, are now illustrated with reference to FIG. 1, which depicts a system 100 for providing vehicle market analysis according to one or more embodiments of the present disclosure. The system 100 may include one or more user devices 105, third-party service provider devices 150, and service provider servers 160 in communication with each other via a network 155.

The user device 105 may include one or more processors 110 in communication with a memory 120. The memory 120 comprise one or more computer-readable storage media (CRSM). In some embodiments, the memory 120 may include non-transitory media such as random access memory (RAM), flash RAM, magnetic media, optical media, solid state media, and so forth. The memory 120 may be volatile (in that information is retained while providing power) or non-volatile (in that information is retained without providing power). Additional embodiments may also be provided as a computer program product including a transitory machine-readable signal (in compressed or uncompressed form). Examples of machine-readable signals include, but are not limited to, signals carried by the Internet or other networks. For example, distribution of software via the Internet may include a transitory machine-readable signal. Additionally, the memory may store an operating system that includes a plurality of computer-executable instructions that may be implemented by the computer processor to perform a variety of tasks to operate the interface(s) and any other hardware installed on the user device 105. The memory may also store content that may be displayed by the user device 105 or transferred to other devices (e.g., headphones) to be displayed or played by the other devices. The memory may also store content received from the other devices. The content from the other devices may be displayed, played, or used by the user device 105 to perform any necessary tasks or operations that may be implemented by the computer processor or other components in the user device 105.

The computer processors 110 may comprise one or more cores and may be configured to access and execute (at least in part) computer-readable instructions stored in the memory 120. The one or more computer processors 110 may include, without limitation: a central processing unit (CPU), a digital signal processor (DSP), a reduced instruction set computer (RISC), a complex instruction set computer (CISC), a microprocessor, a microcontroller, a field programmable gate array (FPGA), or any combination thereof. The user device 105 may also include a chipset (not shown) for controlling communications between the one or more processors and one or more of the other components of the user device 102.

The memory 120 may store a variety of user applications and other data having instructions to be executed by the processor(s) 110. For example, the memory 120 may store a service provider application 125a, which may include a wholesale market module 130a and retail market module 135a. Furthermore, the memory 120 may also store a web browser 140.

The user device 105 may also include a display 145 used to display various information, such as a user interface, for example. Furthermore, the display 145 may include, but is not limited to, a liquid crystal display, a light-emitted diode display, a projector display, a wearable display, and/or an E-Ink™ display as made by E Ink Corp. of Cambridge, Mass. The display may be used to show content to a user in the form of text, images, or video. In certain instances, the display 145 may also operate as a touch screen display that may enable the user to initiate commands or operations by touching the screen using certain finger or hand gestures.

According to some embodiments, the system 100 may also include one or more service provider servers 160 in communication with the user device(s) 105 through one or more networks 155. The service provider server(s) 160 may include processor(s) 165 in communication with memory 180. The memory may store an operating system 185 and a service provider application 125b, which may include a wholesale market module 130b and a retail market module 135b. Additionally, the service provider server(s) 155 may include Input/Output (I/O) devices 170 and storage 175. The I/O devices 170 may include various peripheral and/or internal components including, but not limited to, keyboards, mice, displays, network interface cards, disk controllers, web cams, and/or other devices. The storage 175 may include any kind of storage devices, such as hard disk drives, solid-state drives, flash drives, tape drives, compact disc drives, DVD drives, Blu-Ray drives, network attached storage, remote storage locations, and/or the like.

The discussion now begins with a broad description of embodiments that may enable providing vehicle market analysis in view of the components illustrated in FIG. 1. Thereafter, such components, and interactions between such components, may be described in more detail with respect to certain embodiments of the present disclosure.

As stated above, the memory 120 of the user device(s) 105 may store one or more service provider applications 125a. In other embodiments, the service provider application 125b may be stored in the service provider server(s) 160, or on both the user device 105 and the service provider server(s) 160. Thus, it should be understood that the operations of the service provider application 125a-b may be performed by the user device 105, the service provider server(s) 160, and/or any combination thereof.

Generally, the service provider application 125a-b may receive vehicle data associated with one or more vehicles input by a user of the user device 105. The vehicle data may include information associated with the one or more vehicles, such as make, model, year, mileage, etc. Based at least in part on the vehicle data, the wholesale market module 130a-b may determine wholesale market data associated with the vehicles, and the retail market module 135a-b may determine retail market data associated with the vehicles. To this end, the wholesale market module 130a-b and/or the retail market module 135a-b may communicate with one or more database(s) 190 and/or one or more third party service device(s) 150. The database(s) 190 may be public databases, or they may be associated with third-party services. Alternatively, they may be proprietary to a service provider associated with the service provider server(s) 160. In certain implementations, the wholesale market data, the retail market data, and/or portions thereof may also be provided by one or more users of the user device(s) 105 and/or one or more third-party users of third party service device(s) 150. Additionally, third party service device(s) 150 may be associated various entities including, but not limited to, banks and other financial institutions, fleet providers, rental car companies, dealers, auctions, and/or any other entity that may facilitate providing data and/or data analysis associated with vehicle or vehicle markets.

According to one or more embodiments, the service provider application 125a-b may analyze the received wholesale market data and retail market data (e.g., received via the wholesale market module 130a-b and the retail market module 135a-b, respectively) to provide market analysis associated with the one or more vehicles represented by the vehicle data. In certain implementations, such market analysis may include determining, by the service provider application 125a-b, and based at least in part on the wholesale market data and/or the retail market data, one or more recommendations for buying and/or selling the vehicles. For instance, the recommendations may include price recommendations that are associated with respective prices at which to buy/sell the vehicles. In addition, the recommendations may also include auction recommendations to determine respective auctions at which to buy/sell the vehicles. Further still, the recommendations may include timing recommendations that indicate a determined time period for which to buy and/or sell vehicles. The above recommendations are discussed in more detail with reference to FIG. 2 below.

In certain embodiments, a user and/or the user device 105 may have the ability to register with the service provider application 125a-b. Registering with the service provider application 125a-b may enable the user to store and/or access one or more sessions for determining vehicle market analysis. For example, in one session with the user device 105, the service provider application 125a-b may determine certain market analysis (e.g., price and/or auction recommendations) associated with a Toyota Camry while in another session with the user device 105, the service provider application 125a-b may determine market analysis associated with a Honda Accord. To this end, the service provider application 125a-b may enable the user to store the sessions on the user device 105, the service provider server(s) 160, another storage device, and/or any combination thereof. As such, the user may be able to view and/or other retrieve the respective stored market analyses associated with the sessions.

Furthermore, in some implementations, notifications indicating one or more changes in the respective market analysis may be provided to the user device 105. For instance, for a certain auction, the market supply of Toyota Camry's being sold may have changed (e.g., there may have been a recent influx of Camry's being sold at the auction), thereby affecting potential sale prices of Camry's at the auction and/or in a particular market. As another example, for a certain market, there may be multiple Camry's with lease terms that are expiring soon (e.g., within a predetermined time period). To this end, the service provider application 125a-b may be configured to detect these changes in market supply and/or price of the Camry's and adjust one or recommendations associated with the Camry accordingly, such as price recommendations that indicate a price at which to buy/sell a vehicle, auction recommendations that indicate one or more auctions to buy/sell the vehicle, and/or timing recommendations that indicate a time period at which to buy/sell the vehicle. Moreover, in certain embodiments, a user may input one or more recommendation rules to further tailor the recommendations provided by the service provider application 125a-b. For example, the user may specify that recommendations are to be within a certain price range, a certain location, a certain time period, or within any/other type of recommendation constraints.

It should be noted that while the service provider application 125a-b has been described as a dedicated application on the user device 105, the service provider application 125a-b may also be presented as a web portal, a series of web pages, a cookie, and/or any combination thereof. To this end, the service provider application 125a-b, and/or the functionality therein, may be accessible to a user through the web browser 140 of the user device 105.

Turning now to FIG. 2, a diagram is provided depicting a data flow 200 for providing vehicle market analysis in accordance with one or more embodiments of the present disclosure. The data flow 200 may begin when a user device 105 inputs, or otherwise provides, vehicle data 210 associated with one or more vehicles to a service provider application 125a-b. As previously discussed, such vehicle data 210 can include various information such as make, model, year, and/or the like that may define certain aspects of the one or more vehicles. After receiving the vehicle data 210, the service provider application 125a-b may be configured to communicate with one or more databases 190 and/or third-party service device(s) 150 to determine, based at least in part on the vehicle data 210, certain market characteristics related to the one or more vehicles.

According some embodiments, such market characteristics may include wholesale market data 215 and/or retail market data 220, which may be stored or accessible by the third-party service device(s) 150 and/or the databases(s) 190. Thus, wholesale market data 215 and retail market data 220, associated with the one or more vehicles represented by the vehicle data 210, may be transmitted to the wholesale market module 130a-b and the retail market module 135a-b, respectively, from the third-party service device(s) 150 and/or the database(s) 190. To this end, the service provider application 125a-b may employ various methods by which to access such market data for the vehicle(s) represented by the vehicle data 210. For example, in some embodiments, such methods may include performing a search, based on the vehicle data 210, on the database 190, the third-party service devices 150, or another component.

In certain implementations, the wholesale market data 215 may include information related to vehicle condition, color, history, wholesale market locations, wholesale pricing information, auction capacity and other auction data, reconditioning data, and/or various other types of data. Retail market data may include, but is not limited to, market day supply data, quantity of vehicles in respective retail markets, retail pricing information, market capacity, and/or other retail information. To this end, the service provider application 125a-b may generate market analysis data 225 based at least in part on the wholesale market data 215 and the retail market data 220.

According to one or more embodiments, the market analysis data 225 may include a determination of where, and at what price, to buy or sell the vehicles represented by the vehicle data 210 in view of multiple wholesale and/or retail markets for those vehicles. To this end, such determinations may be realized in the form of one or more recommendations to the user for buying/selling vehicles at certain locations and a certain prices. Alternatively, the market analysis data 225 may be presented as simply data to the user, and the user may decide a course of action (or non-action) to take with respect to such data.

In certain implementations, the market analysis data 225 may consider the impact sales of the one or more vehicles represented by the vehicle data 210 would have on various markets and/or locations. For example, consider a scenario in which the user desires to sell 100 Toyota Camry's. The service provider application 125a-b may determine, for respective markets, a degree or amount by which selling all 100 Camrys would affect the sales prices (e.g., how much they would drive down the sales prices) the user could obtain for those Camrys. Thus, the service application 125a-b may determine that sales of the 100 Camrys should be divided among multiple markets and/or locations. Additionally, the market analysis data 225 may also include information related to quantities of other similar vehicles to the target vehicles, which may be entering certain markets. For example, the service provider application 125a-b may determine that at auction A, the user could obtain $20,000 for each of the 100 Camrys and that at auction B, the user could obtain $19,500 for the respective Camrys. However, the service provider application 125a-b may also be aware that an influx of Camrys will soon be entering auction A from another source, which will (or likely will) drive the sales price the user could obtain for the 100 Camrys at auction A down to $19,000. Thus, the service provider application 125a-b may determine that the user should sell the 100 Camrys at auction B, rather than at auction A.

Furthermore, other costs and considerations may similarly affect such determinations to those described above. For instance, consideration of transportation costs may be included in the market analysis data 225. Continuing with the above example, the service provider application 125a-b may determine that the user may obtain a higher sales price for the 100 Camrys at auction A than at auction B. However, the service application 125a-b may also determine the transportation costs for transporting the 100 Camrys to auction A to be prohibitively expensive compared to the transportation costs for transporting the Camrys to auction B. For instance, the service application 125a-b may determine the transportation costs associated with auction A to be $1000 dollars for each vehicle while transportation costs associated with auction B to be $200 for each vehicle, thereby making auction B the more cost-effective auction at which to sell the Camrys.

It should be understood that data values described above are merely exemplary and that other values are also possible. Moreover, while the above data points and factors considered in the market analysis data 225 may be described with respect to their individual effects on certain determinations, it should be understood that any combination of such data points and factors may also be considered by the service provider application 125a-b.

Turning now to FIG. 3, a flow diagram is illustrated of a method 300 for providing vehicle market analysis in accordance with one or more aspects of the present disclosure. The method 300 may begin in block 310 where a service provider application 125a-b, such as in a user device 105, a service provider server 160, and/or any other device, may receive vehicle data associated with a vehicle. As previously discussed, vehicle data may include identifying features of the vehicle, such as make, model, year, and/or the like.

In block 320, the service provider application 125a-b may determine, based at least in part on the vehicle data, wholesale market data and retail market data associated with the vehicle. In certain embodiments, the wholesale market data and the retail market data may be ascertained by communication with one or third-party service devices 150 and/or one or more databases 190. As described below, the wholesale market data and the retail market data may provide the basis for determining certain market analysis of the vehicle in the form of various recommendations.

In block 330, the service provider application 125a-b may determine, based at least in part on the wholesale market data and the retail market data, one or more price recommendations for the vehicle. Similarly, in block 340, the service provider application 125a-b may determine, based at least in part on the wholesale market data and the retail market data, one or more auction recommendations for the vehicle. As such, the one or more price recommendations and the one or more auction recommendations may relate to respectively determining prices and auction (e.g., market and/or locations) at which to buy and/or sell the vehicle.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus may create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
receiving, by a computer comprising one or more processors, vehicle data associated with one or more vehicles;
determining, based at least in part on the vehicle data, wholesale market data and retail market data associated with respective vehicles of the one or more vehicles;
determining, based at least in part on the wholesale market data and the retail market data, one or more price recommendations for respective vehicles of the one or more vehicles; and
determining, based at least in part on the wholesale market data and the retail market data, one or more auction recommendations for respective vehicles of the one or more vehicles.

2. The method of claim 1, further comprising transmitting the one or more price recommendations and the one or more auction recommendations to a user, wherein the one or more price recommendations comprises one or more wholesale price recommendations.

3. The method of claim 1, wherein the vehicle data comprises at least one of a make, model, year, or mileage.

4. The method of claim 1, wherein the wholesale data comprises data associated with at least one of a vehicle history, vehicle color, vehicle condition, or reconditioning cost.

5. The method of claim 1, wherein the retail data comprises data associated with at least one of a market day supply, inventory supply, or transportation cost.

6. The method of claim 1, wherein the one or more price recommendations comprise one or more offer price recommendations at which to sell respective vehicles of the one or more vehicles.

7. The method of claim 6, wherein determining the one or more auction recommendations comprises determining one or more auctions, based on respective locations of the one or more auctions, at which to sell respective vehicles of the one or more vehicles.

8. The method of claim 1, wherein the one or more price recommendations comprise one or more purchase price recommendations.

9. The method of claim 8, wherein determining the one or more auction recommendations comprises determining one or more auctions, based on respective locations of the one or more auctions, at which to purchase respective vehicles of the one or more vehicles.

10. The method of claim 1, wherein determining the one or more auction recommendations comprises determining, for one or more auctions, respective market capacities associated with respective locations of the one or more auctions.

11. The method of claim 1, further comprising determining respective quantities at which to buy or sell respective vehicles of the one or more vehicles.

12. The method of claim 1, further comprising generating a notification to indicate one or more changes to market conditions associated with the one or more price recommendations or the one or more auction recommendations.

13. The method of claim 1, further comprising determining, based at least in part on the wholesale market data and the retail market data, one or more timing recommendations that indicate a time period at which to buy or sell the respective vehicles of the one or more vehicle.

14. A system, comprising
at least one memory storing computer-executable instructions; and
at least one processor configured to execute the computer-executable instructions to:
receive a request for vehicle data associated with one or more vehicles;
determine, based at least in part on the vehicle data, wholesale market data and retail market data associated with respective vehicles of the one or more vehicles;
determine, based at least in part on the wholesale market data and the retail market data, one or more price recommendations for respective vehicles of the one or more vehicles; and
determine, based at least in part on the wholesale market data and the retail market data, one or more auction recommendations for respective vehicles of the one or more vehicles.

15. The system of claim 14, wherein the computer-executable instructions further cause the at least one processor to transmit the one or more price recommendations and the one or more auction recommendations to a user.

16. The system of claim 14, wherein the vehicle data comprises at least one of a make, model, year, or mileage.

17. The system of claim 14, wherein the wholesale data comprises data associated with at least one of a vehicle history, vehicle color, vehicle condition, or reconditioning cost.

18. The system of claim 14, wherein the retail data comprises data associated with at least one of an average price, market day supply, inventory supply, or transportation cost.

19. The system of claim 14, wherein the one or more price recommendations comprise one or more offer price recommendations at which to sell respective vehicles of the one or more vehicles.

20. The system of claim 19, wherein the computer-executable instructions to determine the one or more auction recommendations comprises instructions to determine one or more auctions, based on respective locations of the one or more auctions, at which to sell respective vehicles of the one or more vehicles.

21. The system of claim 14, wherein the one or more price recommendations comprise one or more purchase price recommendations.

22. The system of claim 21, wherein the computer-executable instructions to determine the one or more auction recommendations comprise instructions to determine one or more auctions, based on respective locations of the one or more auctions, at which to purchase respective vehicles of the one or more vehicles.

23. The system of claim 14, wherein the computer-executable instructions to determine the one or more auction recommendations comprise instructions to determine, for one or more auctions, respective market capacities associated with respective locations of the one or more auctions.

24. The system of claim 14, wherein the computer-executable instructions further cause the at least one processor to determine respective quantities at which to buy or sell respective vehicles of the one or more vehicles.

25. The system of claim 14, wherein the computer-executable instructions further cause the at least one processor to generate a notification to indicate one or more changes to market conditions associated with the one or more vehicles.

26. A non-transitory computer readable medium storing instructions, that when executed by at least one processor, causes the at least one processor to:
receive a request vehicle data associated with one or more vehicles;
determine, based at least in part on the vehicle data, wholesale market data and retail market data associated with respective vehicles of the one or more vehicles;
determine, based at least in part on the wholesale market data and the retail market data, one or more price recommendations for respective vehicles of the one or more vehicles; and
determine, based at least in part on the wholesale market data and the retail market data, one or more auction recommendations for respective vehicles of the one or more vehicles.
